(19) United States
(12) Patent Application Publication
(10) Pub. No.: US 2022/0244446 A1
(43) Pub. Date: Aug. 4, 2022

(54) WINDOW WITH LIGHT PIPE AND LIGHT-SCATTERING STRUCTURES

(71) Applicant: CORNING INCORPORATED, Corning, NY (US)

(72) Inventors: Thomas Bertin-Mourot, Paris (FR); James Gregory Couillard, Ithaca, NY (US); Byung Yun Joo, Ithaca, NY (US); James Andrew West, Painted Post, NY (US)

(21) Appl. No.: 17/615,678

(22) PCT Filed: May 28, 2020
(86) PCT No.: PCT/US2020/034867

§ 371 Date: Dec. 1, 2021

Related U.S. Application Data
(60) Provisional application No. 62/856,986, filed on Jun. 4, 2019.

(51) Int. Cl. F21V 8/00; E06B 3/66

(52) U.S. Cl. CPC G02B 6/0036; E06B 3/66; G02B 6/0095; G02B 6/0043

(57) ABSTRACT

An apparatus includes first, second, and third glass portions, with the third glass portion between the first and the second, where the first, second, and third glass portions are configured in spaced relation from each other. The third glass portion is substantially parallel to the first glass portion. A light source emits light into the third glass portion via an edge of the third glass portion. Light-scattering structures scatter at least a portion of the light emitted by the light source into the third glass portion in a direction substantially perpendicular to a primary face of the third glass portion.

### CROSS-REFERENCE TO RELATED APPLICATIONS

This application claims the benefit of priority under 35 U.S.C. § 119 of U.S. Provisional Application No. 62/856,986 filed Jun. 4, 2019, the content of which is incorporated herein by reference in its entirety.

### BACKGROUND

Generally, certain inventive techniques disclosed herein relate to insulated glazing units (IGUs), such as triple-pane or quadruple-pane glass IGUs. In particular, certain inventive techniques involve using an internal pane of such IGUs (also referred to as windows) as a light pipe, where the internal pane includes scattering structures to scatter light in a direction substantially perpendicular to the primary face of the internal pane.

One of the primary functions of windows is to permit exterior or outdoor light to project into an interior space. This may be especially true of roof windows and skylights. However, whenever exterior light, such as sunlight, is not available or is too faint, other light sources (such as lamps or other light fixtures) may be used to create a sufficiently-lit environment.

### SUMMARY

According to certain inventive techniques, an apparatus (e.g., an IGU) includes first, second, and third glass portions. The second glass portion may be substantially parallel to the first glass portion. The third glass portion may be between the first glass portion and the second glass portion. The third glass portion may be substantially parallel to the first glass portion. A first isolated gaseous region may be between the first glass portion and the third glass portion. A second isolated gaseous region may be between the second glass portion and the third glass portion. At least one light source may emit light into the third glass portion via an edge of the third glass portion. A plurality of light-scattering structures may scatter at least a portion of the light emitted by the at least one light source into the third glass portion in a direction substantially perpendicular to a primary face of the third glass portion. The light-scattering structures (e.g., hollow regions that may be formed with a laser, prismatic light reflectors, truncated pyramids, or the like) may be contained within the third glass portion.

A light-scattering layer may be adhered to the third glass portion. The light-scattering layer (e.g., including an optically clear resin) may include the plurality of light-scattering structures. The absolute value of the difference between an index of refraction of the light-scattering layer and an index of refraction of the third glass portion may be less than or equal to 0.05. The third glass portion may have a visible light attenuation coefficient of less than 0.62 per meter for the wavelength range 400-700 nm. The coefficient of thermal expansion for the third glass portion may be less than a coefficient of thermal expansion for the first glass portion and/or the second glass portion. The light scattered from the third glass portion towards the first glass portion may be greater in intensity than the light scattered from the third glass portion towards the second glass portion. The thickness of the third glass portion may be substantially constant.

According to certain inventive techniques, an apparatus includes first, second, third, and fourth substantially parallel glass portions. The third glass portion may be between the first glass portion and the second glass portion. The fourth glass portion may be between the first glass portion and the third glass portion, or between the second glass portion and the third glass portion. According to one technique, a plurality of glass portions are between the first glass portion and the third glass portion, or between the second glass portion and the third glass portion. Three different isolated gaseous regions may be located between the four different glass portions. At least one light source may emit light into the third glass portion via an edge of the third glass portion. A plurality of light-scattering structures (e.g., hollow regions that may be formed with a laser, prismatic light reflectors, truncated pyramids, or the like) may scatter at least a portion of the light emitted by the at least one light source into the third glass portion in a direction substantially perpendicular to a primary face of the third glass portion. A light-scattering layer may be adhered to the third glass portion. The light-scattering layer may include the light-scattering structures.

In one aspect, an apparatus is provided, comprising: a first glass portion; a second glass portion substantially parallel to the first glass portion; a third glass portion between the first glass portion and the second glass portion, wherein: the third glass portion is substantially parallel to the first glass portion; a first isolated gaseous region is between the first glass portion and the third glass portion; and a second isolated gaseous region is between the second glass portion and the third glass portion; at least one light source configured to emit light into the third glass portion via an edge of the third glass portion; and a plurality of light-scattering structures arranged to scatter at least a portion of the light emitted by the at least one light source into the third glass portion in a direction substantially perpendicular to a primary face of the third glass portion.

In one or more embodiments, the plurality of light-scattering structures are contained within the third glass portion.

In one or more embodiments, the plurality of light-scattering structures comprise a plurality of hollow regions.

In one or more embodiments, the plurality of hollow regions comprise a plurality of laser-formed hollow regions.

In one or more embodiments, the apparatus further comprises a light-scattering layer adhered to the third glass portion, wherein the light-scattering layer comprises the plurality of light-scattering structures.

In one or more embodiments, the light-scattering layer comprises a substantially optically clear resin.

In one or more embodiments, the absolute value of a difference between an index of refraction of the light-scattering layer and an index of refraction of the third glass portion is less than or equal to 0.05.

In one or more embodiments, the plurality of light-scattering structures comprise a plurality of prismatic light reflectors.

In one or more embodiments, the plurality of light-scattering structures comprise a plurality of truncated pyramids.

In one or more embodiments, the third glass portion comprises a visible light attenuation coefficient of less than 0.62 per meter.

In one or more embodiments, a coefficient of thermal expansion for the third glass portion is less than a coefficient of thermal expansion for at least one of the first glass portion and the second glass portion.

In one or more embodiments, the coefficient of thermal expansion of the third glass portion is less than the coefficient of thermal expansion for both of the first glass portion and the second glass portion.

In one or more embodiments, an intensity of light scattered from the third glass portion towards the first glass portion is greater than an intensity of light scattered from the third glass portion towards the second glass portion.

In one or more embodiments, the thickness of the third glass portion is substantially constant.

In one aspect, an apparatus is provided, comprising: a first glass portion; a second glass portion substantially parallel to the first glass portion; a third glass portion between the first glass portion and the second glass portion, wherein the third glass portion is substantially parallel to the first glass portion; a fourth glass portion between at least one of the third glass portion and the first glass portion, or the third glass portion and the second glass portion, wherein: the fourth glass portion is substantially parallel to the first glass portion; and three isolated gaseous regions are located between the first, second, third, and fourth glass portions; at least one light source configured to emit light into the third glass portion via an edge of the third glass portion; and a plurality of light-scattering structures arranged to scatter at least a portion of the light emitted by the at least one light source into the third glass portion in a direction substantially perpendicular to a primary face of the third glass portion.

In one or more embodiments, the plurality of light-scattering structures are contained within the third glass portion.

In one or more embodiments, the plurality of light-scattering structures include a plurality of hollow regions.

In one or more embodiments, the apparatus further comprises a light-scattering layer adhered to the third glass portion, wherein the light-scattering layer comprises the plurality of light-scattering structures.

In one or more embodiments, the plurality of light-scattering structures include a plurality of prismatic light reflectors.

In one or more embodiments, the thickness of the third glass portion is substantially constant.

In one or more embodiments, the apparatus further comprises a plurality of glass portions between at least one of the third glass portion and the first glass portion, or the third glass portion and the second glass portion.

### BRIEF DESCRIPTION OF SEVERAL VIEWS OF THE DRAWINGS

FIG. 1A illustrates a triple-pane IGU in which the middle pane pipes light from at least one light source, according to certain inventive techniques.

FIG. 1B illustrates a quadruple-pane IGU in which one of the middle panes pipes light from at least one light source, according to certain inventive techniques.

FIG. 1C illustrates a quadruple-pane IGU in which one of the middle panes pipes light from at least one light source, according to certain inventive techniques.

FIG. 2A illustrates light being internally propagated in an IGU pane, where some of the light scatters outside of the window pane due to a light-scattering structure, according to certain inventive techniques.

FIG. 2B illustrates light being internally propagated in an IGU pane, where some of the light scatters outside of the pane due to a light-scattering structure, according to certain inventive techniques.

FIG. 3A illustrates light-scattering structures embossed onto an IGU pane, according to certain inventive techniques.

FIG. 3B illustrates a light-scattering layer with light-scattering structures adhered to an IGU pane, according to certain inventive techniques.

FIG. 3C illustrates a light-scattering layer with light-scattering structures adhered to an IGU pane, according to certain inventive techniques.

FIG. 3D illustrates an IGU pane including light-scattering structures that are hollow regions, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

Certain inventive techniques disclosed herein describe a triple-pane or quadruple-pane (or greater) insulated glazing unit (IGU) (and, as may be the case, associated components) that can selectively illuminate a middle pane to provide additional light into a target environment. The middle pane may serve as a light pipe that pipes light received at an edge of the middle pane. Scattering structures may promote the piped light to be scattered and emitted from the middle pane into the target environment.

Edge lighting technology using light sources, such as LEDs or fluorescent tubes may provide a relatively smooth illumination over the surface of a light pipe. Such light could even mimic sunlight if the correct wavelengths are into the light pipe. Acrylic sheets may be used as a light pipe, however these may be vulnerable to degradation in a typical window environment, such as yellowing due to ultraviolet light exposure and/or breakage due to the thermal stresses. Soda-lime glass may also be used as a light pipe, but such a glass may have relatively high optical attenuation coefficient which may not be uniform across the visible spectrum leading to a color shift of the extracted light relative to the color of the input light source. This may limit the window size, light efficiency, and color rendering when soda-lime glass is used. Certain inventive techniques disclosed herein address these issues through the use and configuration of certain glasses, such as Corning® Iris™ or EAGLE XG® glass, that are resistant to yellowing and breakage. Such glasses may also have relatively low optical attenuation coefficients that may be relatively uniform across the visible spectrum.

Color shift as described herein can be characterized by measuring the variation in y chromaticity coordinate of the extracted light along a length L using the CIE 1931 standard for color measurements. For glass light-guide plates the dimensionless value of color shift can be reported as Δy=|y(Lf)−y(Li)| where Lf and Li are Z positions along the panel or substrate direction away from the source launch and where Lf−Li=0.5 meters. Exemplary light-guide plates have Δy<0.01, Δy<0.005, Δy<0.003, or Δy<0.001.

Particles, such as dust or other visible particles may land on the outer surface of a light pipe. The presence of such particles may cause the external illumination from the light pipe to look irregular or uneven. Certain inventive techniques inhibit the collection of particles on the outer surface of the light pipe, for example, by insulating the light pipe with at least two isolated gaseous regions.

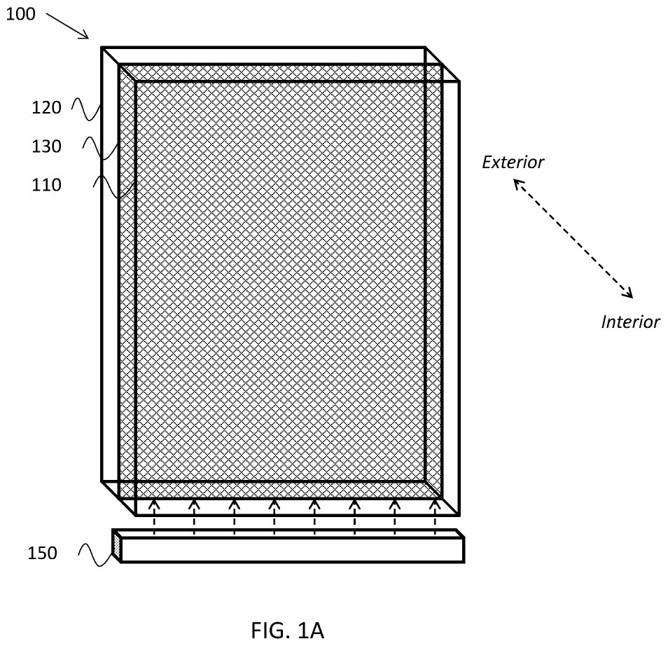

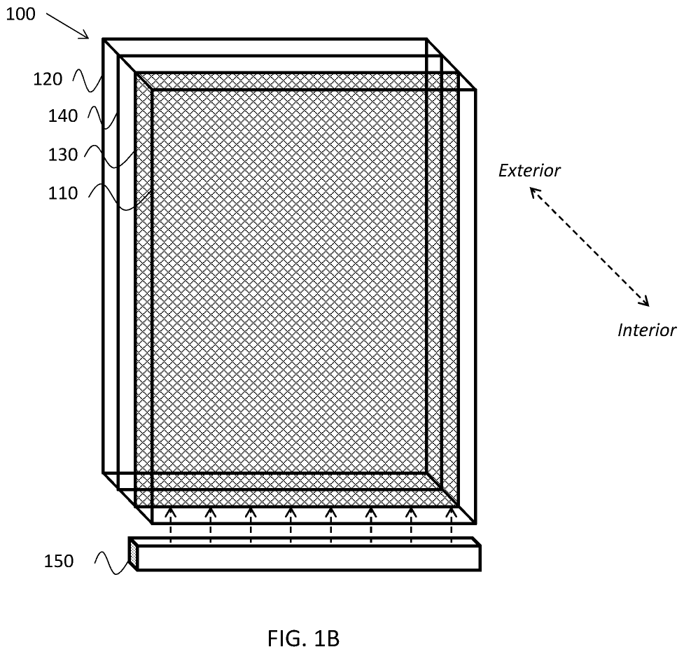

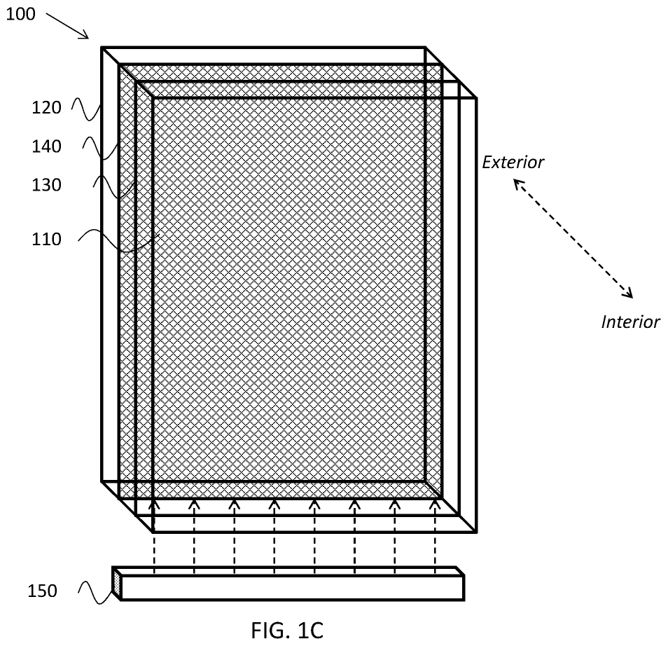

FIG. 1A illustrates a triple-pane IGU 100 in which the middle pane 130 pipes light from at least one light source 150, according to certain inventive techniques. IGU 100, according to this technique, may include exterior pane 120, interior pane 110, and middle pane 130. By “middle,” it is understood that middle pane 130 is in between exterior pane 120 and interior pane 110, not necessarily positioned precisely in the center (in terms of distance) of exterior pane 120 and interior pane 110. Panes 110, 120, and 130 (and other panes disclosed herein) may include a material such as glass. While this disclosure is primarily with respect to glass panes, it may be possible to use other materials such as polymers, including polymethyl methacrylate (PMMA), methyl methacrylate styrene (MS), polycarbonate (PC), glass-glass laminates, and glass-polymer laminates.

Middle pane 130 may include glass, such as Corning Iris or EAGLE XG glass. Exterior pane 120 and interior pane 110 may include such glass or other types of glass, such as soda lime silicate, low iron glass, tinted glass, or glass-glass laminates. The choice of materials for exterior pane 120 and interior pane 110 may be selected for reasons of cost, aesthetics, and/or safety considerations. Middle pane 130 may be chemically and/or thermally strengthened to withstand thermal gradients that may be induced in IGU 100. Such gradients may be 40° C. or more. Alternatively, middle pane 130 may include a glass having relatively a low coefficient of thermal expansion (CTE), such as a CTE less than 5×10⁻⁶/° C. Middle pane 130 may have a visible-light absorption coefficient of less than 0.62 m⁻¹.

The thickness of middle pane 130 may be below 2 mm or 1 mm. Having a relatively thin middle pane 130 may reduce weight and/or increase the thermal insulation properties of IGU 100. Middle pane 130 may have relatively good resistance to solarization, UV yellowing, and moisture with time.

A first isolated gaseous region may be located between interior pane 110 and middle pane 130. The first isolated gaseous region may be formed by placing a spacer between interior pane 110 and middle pane 130 that separates the two panes of glass and seals the gas space between them. The first isolated gaseous region may range in thickness from 6 mm to 25 mm, and may serve to reduce heat transfer between interior pane 110 and middle pane 130. The first isolated gaseous region may be filled with air, argon, krypton, or mixtures thereof. A second isolated gaseous region may be located between exterior pane 120 and middle pane 130. The first and second isolated gaseous regions may be substantially similar.

Light source 150 may emit light into an interior region of middle pane 130. Light source 150 may employ edge lighting technology using, for example, an array of individual LED, an array of laser diodes or CCFL fluorescent tubes. Light source 150 may include more than one individual light-emitting element (e.g., a single LED). A collection of such individual light-emitting elements may be considered to be a light source 150. Alternatively, light source 150 may consist of only one light-emitting element. If a plurality of light sources is used, the individual light sources may have an identical emission spectrum, or they may have different emission spectra. A selection of LEDs with nominally red, green and blue emission spectra may be mixed to produce a wide range of colors that can be tune dynamically by changing the relative intensities of the red, green and blue sources.

LEDs and CCFL light sources are known to emit light into a wide angular range that cannot be captured by middle pane 130. Light source 150 may be surrounded by a reflective optical cavity to capture light that would not otherwise be captured by middle pane 130. Light source 150 and optical cavity form a source assembly whose optical angular emission properties are chosen to maximize the optical coupling of light source 150 into middle pane 130. Specifically, the gap between the emitting surface of light source 150 and the input surface of middle pane 130 should be less than 0.5 mm.

Such edge lighting techniques may provide a surfacic and relatively smooth illumination on the surface of a light pipe that receives the light from light source 150. Such illumination may mimic sunlight if appropriate light wavelengths are injected. A second light source (not shown) may be used to inject light into middle pane 130 through its opposite edge (i.e., the top edge as depicted in FIG. 1A). Light source(s) 150 may be used to emit light into middle pane 130 through any available edge, including side edges.

FIG. 1B illustrates a quadruple-pane IGU 100 in which middle pane 130 pipes light from at least one light source 150, according to certain inventive techniques. The quadruple-pane IGU 100 depicted in FIG. 1B may be similar in many respects to the triple-pane IGU 100 depicted in FIG. 1A. Of course, the quadruple-pane IGU 100 has four panes of glass 110, 120, 130, and 140. FIG. 1C illustrates an alternative arrangement a quadruple-pane IGU 100.

It may also be possible to include five or more panes of glass (not shown) in the IGU 100. According to one example, a plurality of panes of glass may be arranged between pane 110 and 130. According to another example, a plurality of panes of glass may be arranged between pane 120 and 130.

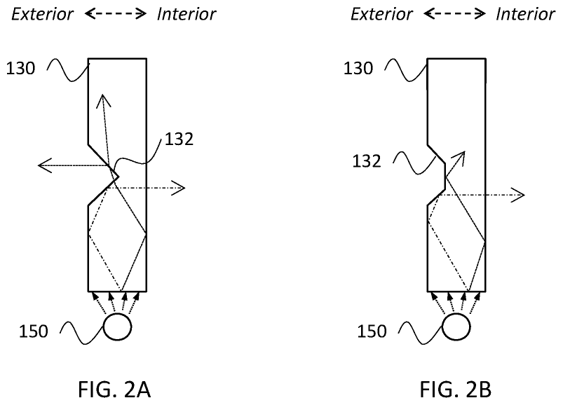

FIG. 2A illustrates light being internally propagated in middle pane 130, where some of the light scatters outside of middle pane 130 due to a light-scattering structure 132, according to certain inventive techniques. Light-scattering structure 132 may be etched or formed in middle pane 130 by removing material from middle pane 130. A plurality of light scattering structures 132 may form a light extraction pattern with the spacing and size of light extraction features chosen to provide the desired illumination pattern across middle pane 130. Techniques for forming the pattern of light scattering structures 132 may include screen printing or inkjet printing light scattering inks and resins, microreplication of a resin coating on middle pane 130 using a pre-patterned mold, laser patterning directly into the optical material of middle pane 130, masking followed by etching middle pane 130 using wet or dry etching techniques, or masking followed by liquid or dry deposition techniques. The shape of light-scattering structure 132 may be an inverted pyramid, with the base (which is actually an aperture or void) extending outwardly and the apex extending inwardly as depicted. According to one technique, light-scattering structure 132 is an inverted square pyramid. Light-scattering structure 132 may be a fully symmetric inverted pyramid. Light-scattering structure 132 may be an inverted right pyramid and may have a regular base (again, the base may be an aperture or a void, as depicted). The sides of light-scattering structure 132 may have isosceles triangle shapes (for example, four sides with the shape of each isosceles triangle being the same).

In the case that light-scattering structure 132 is an inverted square pyramid with full symmetry, an acute angle e between a side of the pyramid and the base of the pyramid may be approximately 50 degrees. The refraction of the extracted light at the surface light extraction structure 132 may determine a preferred angle of the light extraction feature 132 for extracting light at normal incidence to middle pane 130. The angular range of the acute angle e between a side of the pyramid and the base of the pyramid may be between 25 degrees and 75 degrees. For such light-scattering structure 132, a length W of a side of the square base may be between approximately 10-200 μm (e.g., 30 μm). The dimensions of light extraction structure 132 may be chosen to provide sufficient light extraction while reducing visibility of the individual light extraction features. It may be useful to have a relatively high density of small features so that they appear uniform to the human eye. If features are too large, they might need to be placed further apart so that they do not extract light too quickly but they may also be more visible to the human eye. For such light-scattering structure 132, a height H (depicted as depth—from base to apex) of light-scattering structure 132 is given by H=(W/2)*tan(θ) and for 0=50 degrees and W=30 μm, H may be approximately 17.9 μm (e.g., 17.876 μm).

FIG. 2B illustrates light being internally propagated in an IGU pane, where some of the light scatters outside of the pane due to light-scattering structure 132, according to certain inventive techniques. Light-scattering structure 132 may be etched or formed in the pane 130 by removing material from the pane 130. Such a light-scattering structure 132 may be formed using microreplication into a thin resin layer attached to middle pane 130 or by using hot embossing of light extraction structures 132 directly into the optical material. The shape of the light-scattering structure 132 may be an inverted truncated pyramid, with the base (which is actually an aperture or void) extending outwardly and the truncated side extending inwardly as depicted. According to one technique, light-scattering structure 132 is an inverted square truncated pyramid. Light-scattering structure 132 may be a fully symmetric inverted truncated pyramid. Light-scattering structure 132 may be a right inverted truncated pyramid and may have a regular base. The sides of light-scattering structure 132 may have the same shapes (for example, four sides with the shape of a trapezoid, each trapezoid being the same).

In the case that light-scattering structure 132 is a square inverted truncated pyramid with full symmetry, an angle between a side of the truncated pyramid and the base of the truncated pyramid may be approximately 50 degrees. The refraction of the extracted light at the surface light-scattering structure 132 determines the optimum angle of the light-scattering structure 132 for extracting light at normal incidence to middle pane 130. The angular range of the acute angle θ between a side of the pyramid and the base of the pyramid may be between 25 degrees and 75 degrees. For such a light-scattering structure 132, a length of a side of the square base may be approximately 10-200 μm (e.g., 30 μm). The dimensions of light-scattering structure 132 may be chosen to provide sufficient light extraction while reducing visibility of the individual light-scattering structures 132. It may be beneficial to have a high density of relatively small structures so that they appear uniform to the human eye. If structures are too large, they must be placed further apart so that they do not extract light too quickly, but then they are more visible. For such a light-scattering structure 132, a height (depicted as depth—from base to apex) of light-scattering structure 132 may be approximately 3 to 10 μm (e.g., approximately 3 μm). The height of light-scattering structure 132 determines the surface area available for light extraction. The maximal height Hmax is determined by Hmax=(W/2)*tan(θ) for which the light extraction feature is a true pyramid. For H<Hmax the optical scattering of the light-scattering structure 132 is decreased but such light extraction features may be more amenable to fabrication and may be more durable because of the flat top.

It may be useful to design an inventive IGU 100 such that light is projected from middle pane 130 primarily into an interior space (e.g., inside a building) and not into the exterior (e.g., outside the building). To evaluate this property of middle pane 130, a ratio between the interior illumination and exterior illumination may be considered. For example, in FIG. 2A, the exterior illumination is light projected to the left of middle pane 130 and the interior illumination is the light projected to the right of middle pane 130. When light-scattering structure 132 has an inverted square pyramidal shape, an interior/exterior luminance ratio may be approximately 7—meaning that the illumination into the interior is 7 times greater than the illumination into the exterior. When light-scattering structure 132 has an inverted truncated square pyramidal shape, the interior/exterior luminance ratio may be 12 or greater (e.g., up to 19, or even greater). In particular, shorter inverted truncated square pyramids (e.g., those with heights of approximately 3 μm) may result in higher interior/exterior luminance ratios (e.g., 19 for the 3 μm case). Some examples of the effect of different pyramid configurations are set forth below in Table 1.

TABLE 1

| | | Base | | Luminance | Relative |
|---|---|---|---|---|---|
| | Pyramid | side | | ratio | luminance |
| Pattern | angle | length | Height | (Interior/ | to Interior |
| Type | (degrees) | (μm) | (μm) | Exterior) | (%) |
| Inverted | 50 | 30 | 17.876 | 7 | 100 |
| Square | | | | | |
| Pyramid | | | | | |
| (Sharp | | | | | |
| apex) | | | | | |
| Inverted | 50 | 30 | 10 | 12 | 83 |
| Truncated | | | | | |
| Square | | | | | |
| Pyramid | | | | | |
| Inverted | 50 | 30 | 5 | 15 | 58 |
| Truncated | | | | | |
| Square | | | | | |
| Pyramid | | | | | |
| Inverted | 50 | 30 | 3 | 19 | 38 |
| Truncated | | | | | |
| Square | | | | | |
| Pyramid | | | | | |

One reason for improved performance with the inverted truncated pyramidal shape may be that the inverted sharp-apex pyramid may demonstrate Fresnel reflections that cause rays to travel in the exterior direction. However, in the inverted truncated pyramidal shape, the chance of Fresnel reflections to the exterior direction may be less, depending on the amount of truncation. When such a pyramid is truncated, the ratio of interior to exterior luminance increases. However, the surface area available for light extraction is decreased in shorter pyramids, leading to less overall extraction of the light (in both interior and exterior directions).

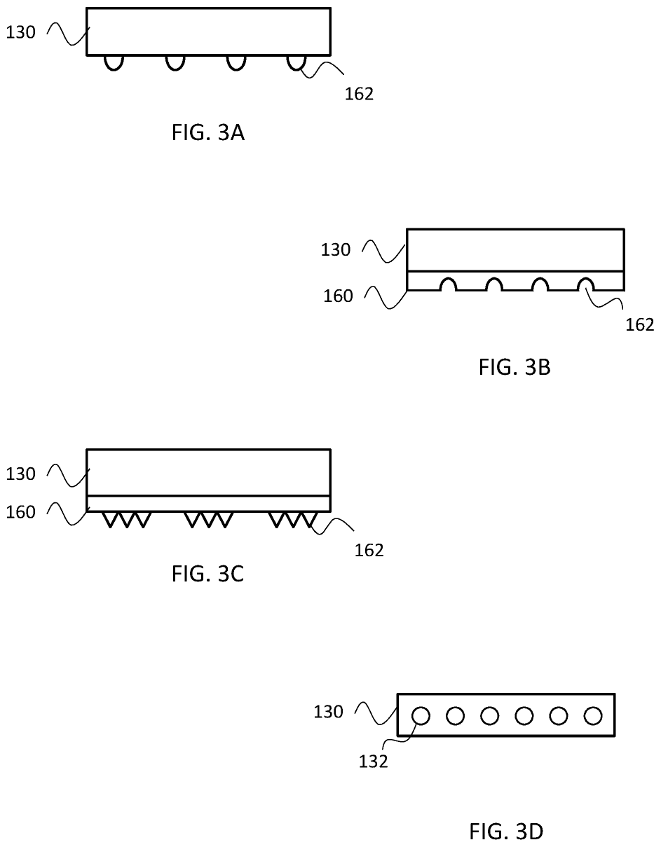

FIG. 3A illustrates light-scattering structures 162 embossed onto middle pane 130, according to certain inventive techniques. Light-scattering structures 162 may be embossed with respect to a surface of middle pane 130 through techniques such as screen printing or inkjet printing light scattering inks and resins, microreplication of a resin coating on middle pane 130 using a pre-patterned mold, laser patterning directly into the optical material of middle pane 130, masking followed by etching middle pane 130 using wet or dry etching techniques, and masking followed by liquid or dry deposition techniques. Light-scattering structures 162 may comprise a resin that is substantially optically clear with an optical attenuation coefficient <300 per meter. Examples of such resins may include, but are not limited to, photo-polymerized materials, heat cured or heat curable materials, thermoplastics, thermosets, epoxies, acrylates, and other suitable binder materials utilized in the industry. A polymeric material may further be chosen from compositions having a low color shift and/or low absorption of visible light wavelengths (e.g., ˜400-700 nm), the polymeric film 120 may be thinly deposited on the light emitting surface of the glass substrate. The polymeric film may be continuous or discontinuous. Such a resin of light-scattering structures 162 may have a refractive index close to that of middle pane 130. For example, the absolute value of the difference between the refractive index of light-scattering structures 162 and middle pane 130 may be less than 0.05. For example, the index of refraction of middle pane 130 may be between approximately 1.45-1.60, whereas the index of refraction of light-scattering structures 162 may be between approximately 1.40-1.70.

The height of a light-scattering structure 162 of the type depicted in FIG. 3A may be approximately 7-8 μm. Such light-scattering structure 162 may have a rounded tip or outer edge(s). The width and height dimensions of the light extraction structure 162 may be chosen to provide sufficient light extraction while reducing visibility of the individual light extraction features. It may be possible to have a high density of small features so that they appear uniform to the human eye. If the features are sufficiently large, they may be placed further apart so that they do not extract light too quickly but then they are more visible. Furthermore, the geometrical shape of the light extraction structure 162 may determine the scattering angle of the extracted light. Rounded light extraction structures 162 that are approximately hemispherical in shape may produce angular scattering of the light whose external angle will be close to normal incidence with the surface of the middle pane 130.

FIG. 3B illustrates light-scattering layer 160 with light-scattering structures 162 adhered to middle pane 130, according to certain inventive techniques. Light-scattering layer 160 may comprise a material such as, but not limited to, photo-polymerized materials, heat cured or heat curable materials, thermoplastics, thermosets, epoxies, acrylates, and other suitable binder materials utilized in the industry. The polymeric material may further be chosen from compositions having a low color shift and/or low absorption of visible light wavelengths (e.g., ˜400-700 nm). The polymeric film may be thinly deposited on the light emitting surface of the glass substrate. The polymeric film may be continuous or discontinuous. Light-scattering layer 160 may be adhered to middle pane 130 through techniques such as, but not limited to, screen printing, slot coating or spin coating. When using a substantially optically clear resin for light-scattering layer 160, such resin may have a refractive index close to that of middle pane 130. For example, the absolute value of the difference between the refractive index of light-scattering layer 160 and middle pane 130 may be less than 0.05.

Light-scattering structures 162 may be formed in light-scattering layer 160 through techniques such as, but not limited to, microreplication, nano-imprinting, laser patterning, mask and etch techniques with wet and dry etchants. The height of light-scattering structures 162 of the type depicted in FIG. 3B may be approximately 5-30 μm. Such a light-scattering structure 162 may be rounded at the bottom or outer edge(s). The width and height dimensions of the light-scattering structure 162 may be chosen to provide sufficient light extraction while reducing visibility of the individual light-scattering structures 162. It may be preferable to have a relatively high density of small features so that they appear uniform to the human eye. If the features are sufficiently large, they may be placed further apart so that they do not extract light too quickly but then they are more visible. Furthermore, the geometrical shape of the light-scattering structure 162 determines the scattering angle of the extracted light. Rounded light-scattering structures 162 that are approximately hemispherical in shape may produce angular scattering of the light whose external angle will be close to normal incidence with the surface of the middle pane 130.

FIG. 3C illustrates a light-scattering layer 160 with light-scattering structures 162, where light-scattering layer 160 is adhered to middle pane 130, according to certain inventive techniques. The shape of individual light-scattering structures 162 may be substantially a square truncated pyramid (for example, with full symmetry), and an angle between a side of the truncated pyramid and the base of the truncated pyramid may be approximately 50 degrees. The refraction of the extracted light at the surface light-scattering structure 162 may determine the optimum angle of the light-scattering structure 162 for extracting light at normal incidence to the middle pane 130. One angular range of the acute angle e between a side of the truncated pyramid and the base of the truncated pyramid is between 25 degrees and 75 degrees. When using a substantially optically clear resin to form light-scattering layer 160 and/or light-scattering structures 162, such resin may have a refractive index close to that of middle pane 130. For example, the absolute value of the difference between the refractive index of light-scattering layer 160 and middle pane 130 may be less than 0.05.

FIG. 3D illustrates middle pane 130 including light-scattering structures 132 that are hollow regions in middle pane 130, according to certain inventive techniques. The voids may be substantially cylindrical in shape with diameters of 1-20 μm and lengths of 20-1000 μm. Such voids may be formed by optical focusing of ultraviolet, visible, or infrared wavelengths of laser light from an optical beam of periodic pulses or periodic bursts of pulses with, for example, pulse durations between 5 femotseconds and 100 nanoseconds. The voids may form due to a combination of nonlinear thermal and optical interactions of the laser beam with the material, for example, as described in U.S. Pat. No. 6,573,026 and N. M. Bulgakova, et al., “Pulsed laser modification of transparent dielectrics: What can be foreseen and predicted by numerical simulations?,” J. Opt. Soc. Am. B 31, C8-C14 (2014). Middle pane 130 may have a relatively low coefficient of thermal expansion (CTE) <80×10⁻⁷/° C., and this may ease formation of subsurface laser features within middle pane 130. This may also allow a higher degree of transmitted light without strength degradation due to cracks which can occur when laser patterning relatively materials having relatively higher CTE. CTE of an oxide glass may be decreased to, for example, <30×10⁻⁷/° C. by reducing the percentage of alkali metal oxides and alkali earth metal oxides in the composition. Such compositions may be employed to further ease formation of subsurface light-scattering structures 132 within middle pane 130.

For glass compositions with coefficients of thermal expansion such that micro-cracking accompanies laser patterning, a wet chemical etching process may be used to remove sufficient material around the laser patterning features to eliminate CTE-induced micro-cracking thus leading to improved strength when the patterned surface is placed under tensile loading. The etching process may consist of a dip, spray, or cream application of a mixture of various acids or bases known to etch multicomponent glasses, including but not limited to, hydrofluoric acid, sulfuric acid, nitric acid, citric acid, ammonium bifluoride, sodium hydroxide, or potassium hydroxide.

Light scattering techniques may be achieved by using any combination of light-scattering structures 132/162 and/or light-scattering layer 160 disclosed in FIGS. 3A-3D, and/or according to other techniques. The surface density of light-scattering structures 132 or 162 (e.g., as measured by the number of structures 132/162 per m²) may be uniform across a surface of middle pane 130, or the density may vary. For example, there may be a density gradient in one or more directions. For example, the number of light-scattering structures 132 or 162 may increase along a direction away from an edge of middle pane 130 according to a density gradient or other techniques. By increasing the density of light-scattering structures 132/162 in a direction away from light source 150, it may be possible to maintain substantially constant glass thickness (e.g., not a changing or tapering thickness) while still achieving relatively constant luminance across an outer surface of middle pane 130. One possible reason for this is that light-scattering structures 132/162 scatter some light out of middle pane 130. Consequently, the amount of light may decrease along a direction away from light source 150. Therefore, light-scattering structures 132/162 closer to light source 150 may scatter more intense light and, as such, fewer light-scattering structures 132/162 (e.g., lower density) may be employed in the region closer to the light source 150. Additionally, light-scattering structures 132/162 distal from light source 150 may scatter less intense light and, as such, more light-scattering structures 132/162 (e.g., higher density) may be employed in this region distal from the light source 150.

According to certain techniques described herein, it may be possible to have greater than 80% of light emitted from the middle pane 130 towards the interior. One potential benefit of prism-shapes light-scattering structures 132 is that they may not only increase the luminance (light intensity per solid angle), they also may increase the overall output flux in the preferred direction. The placement of light-scattering structures 132 can be chosen to produce the desired luminance distribution, maximize output flux and to minimize the dot visibility.

The middle pane 130 (or other IGU panes) may have a glass composition between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂.

In further embodiments, exemplary glass compositions comprise between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂. In some embodiments, a respective glass article comprises a color shift <0.008 or <0.005.

In additional embodiments, exemplary glass compositions comprise between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂.

In additional embodiments, exemplary glass compositions comprise between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm.

In yet further embodiments, exemplary glass compositions comprise between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein the glass has a color shift <0.008.

In other embodiments, exemplary glass compositions comprise between about 65.79 mol % to about 78.17 mol % SiO₂, between about 2.94 mol % to about 12.12 mol % Al₂O₃, between about 0 mol % to about 11.16 mol % B₂O₃, and about 3.52 mol % to about 42.39 mol % RₓO, wherein R is any one or more of Li, Na, K, Rb, Cs and x is 2, or Zn, Mg, Ca, Sr or Ba and x is 1, and wherein the glass has a color shift <0.008.

In further embodiments, exemplary glass compositions comprise between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, between about 0 mol % to about 2 mol % SrO, and wherein Fe+30Cr+35Ni<about 60 ppm.

In additional embodiments, exemplary glass compositions comprise between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, and between about 0 mol % to about 2 mol % SrO, wherein the glass has a color shift <0.008.

In some embodiments, a respective glass article comprises a color shift <0.008 or <0.005. In some embodiments, the glass comprises an RₓO/Al₂O₃ between 0.95 and 3.23, wherein R is any one or more of Li, Na, K, Rb, Cs and x is 2. In some embodiments, the glass comprises an RₓO/Al₂O₃ between 1.18 and 5.68, wherein R is any one or more of Li, Na, K, Rb, Cs and x is 2, or Zn, Mg, Ca, Sr or Ba and x is 1. In some embodiments, the glass article comprises an RₓO-Al₂O₃-MgO between −4.25 and 4.0, wherein R is any one or more of Li, Na, K, Rb, Cs and x is 2. In some embodiments, the glass comprises less than 1 ppm each of Co, Ni, and Cr. In some embodiments, the concentration of Fe is <about 50 ppm, <about 20 ppm, or <about 10 ppm. In some embodiments, Fe+30Cr +35Ni<about 60 ppm, <about 40 ppm, <about 20 ppm, or <about 10 ppm. In some embodiments, the transmittance at 450 nm with at least 500 mm in length is greater than or equal to 85%, the transmittance at 550 nm with at least 500 mm in length is greater than or equal to 90%, or the transmittance at 630 nm with at least 500 mm in length is greater than or equal to 85%, and combinations thereof. In some embodiments, the glass sheet is chemically strengthened. In further embodiments, the glass comprises from about 0.1 mol % to about 3.0 mol % ZnO, from about 0.1 mol % to about 1.0 mol % TiO₂, from about 0.1 mol % to about 1.0 mol % V₂O₃, from about 0.1 mol % to about 1.0 mol % Nb₂O₅, from about 0.1 mol % to about 1.0 mol % MnO, from about 0.1 mol % to about 1.0 mol % ZrO₂, from about 0.1 mol % to about 1.0 mol % As₂O₃, from about 0.1 mol % to about 1.0 mol % SnO₂, from about 0.1 mol % to about 1.0 mol % MoO₃, from about 0.1 mol % to about 1.0 mol % Sb₂O₃, or from about 0.1 mol % to about 1.0 mol % CeO₂. In additional embodiments, the glass comprises between 0.1 mol % to no more than about 3.0 mol % of one or combination of any of ZnO, TiO₂, V₂O₃, Nb₂O₅, MnO, ZrO₂, As₂O₃, SnO₂, MoO₃, Sb₂O₃, and CeO₂.

In additional embodiments, exemplary glass compositions comprise between about 50-80 mol % SiO₂, between 0-20 mol % Al₂O₃, and between 0-25 mol % B₂O₃, and less than 50 ppm iron (Fe) concentration.

In additional embodiments, exemplary glass compositions comprise between about 70 mol % to about 85 mol % SiO₂, between about 0 mol % to about 5 mol % Al₂O₃, between about 0 mol % to about 5 mol % B₂O₃, between about 0 mol % to about 10 mol % Na₂O, between about 0 mol % to about 12 mol % K₂O, between about 0 mol % to about 4 mol % ZnO, between about 3 mol % to about 12 mol % MgO, between about 0 mol % to about 5 mol % CaO, between about 0 mol % to about 3 mol % SrO, between about 0 mol % to about 3 mol % BaO, and between about 0.01 mol % to about 0.5 mol % SnO₂.

In additional embodiments, exemplary glass compositions comprise between about 80 mol % SiO₂, between about 0 mol % to about 0.5 mol % Al₂O₃, between about 0 mol % to about 0.5 mol % B₂O₃, between about 0 mol % to about 0.5 mol % Na₂O, between about 8 mol % to about 11 mol % K₂O, between about 0.01 mol % to about 4 mol % ZnO, between about 6 mol % to about 10 mol % MgO, between about 0 mol % to about 0.5 mol % CaO, between about 0 mol % to about 0.5 mol % SrO, between about 0 mol % to about 0.5 mol % BaO, and between about 0.01 mol % to about 0.11 mol % SnO₂.

In additional embodiments, exemplary glass compositions are substantially free of Al₂O₃ and B₂O₃ and comprises greater than about 80 mol % SiO₂, between about 0 mol % to about 0.5 mol % Na₂O, between about 8 mol % to about 11 mol % K₂O, between about 0.01 mol % to about 4 mol % ZnO, between about 6 mol % to about 10 mol % MgO, and between about 0.01 mol % to about 0.11 mol % SnO₂. In some embodiments, the glass sheet is substantially free of B₂O₃, Na₂O, CaO, SrO, or BaO, and combinations thereof.

In additional embodiments, exemplary glass compositions is an alumina free, potassium silicate composition comprising greater than about 80 mol % SiO₂, between about 8 mol % to about 11 mol % K₂O, between about 0.01 mol % to about 4 mol % ZnO, between about 6 mol % to about 10 mol % MgO, and between about 0.01 mol % to about 0.11 mol % SnO₂. In some embodiments, the glass sheet is substantially free of B₂O₃, Na₂O, CaO, SrO, or BaO, and combinations thereof.

In some embodiments, exemplary glass compositions comprise between about 72.82 mol % to about 82.03 mol % SiO₂, between about 0 mol % to about 4.8 mol % Al₂O₃, between about 0 mol % to about 2.77 mol % B₂O₃, between about 0 mol % to about 9.28 mol % Na₂O, between about 0.58 mol % to about 10.58 mol % K₂O, between about 0 mol % to about 2.93 mol % ZnO, between about 3.1 mol % to about 10.58 mol % MgO, between about 0 mol % to about 4.82 mol % CaO, between about 0 mol % to about 1.59 mol % SrO, between about 0 mol % to about 3 mol % BaO, and between about 0.08 mol % to about 0.15 mol % SnO₂. In further embodiments, the glass sheet is substantially free of Al₂O₃, B₂O₃, Na₂O, CaO, SrO, or BaO, and combinations thereof.

In additional embodiments, exemplary glass compositions are substantially free of Al₂O₃ and B₂O₃ and comprises greater than about 80 mol % SiO₂, and wherein the glass has a color shift <0.005. In some embodiments, the glass sheet comprises between about 8 mol % to about 11 mol % K₂O, between about 0.01 mol % to about 4 mol % ZnO, between about 6 mol % to about 10 mol % MgO, and between about 0.01 mol % to about 0.11 mol % SnO₂.

In additional embodiments, exemplary glass compositions are substantially free of Al₂O₃, B₂O₃, Na₂O, CaO, SrO, and BaO, and wherein the glass has a color shift <0.005. In some embodiments, the glass sheet comprises greater than about 80 mol % SiO₂. In some embodiments, the glass sheet comprises between about 8 mol % to about 11 mol % K₂O, between about 0.01 mol % to about 4 mol % ZnO, between about 6 mol % to about 10 mol % MgO, and between about 0.01 mol % to about 0.11 mol % SnO₂.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. An apparatus, comprising:
a first glass portion;
a second glass portion substantially parallel to the first glass portion;
a third glass portion between the first glass portion and the second glass portion,
wherein:
the third glass portion is substantially parallel to the first glass portion;
a first isolated gaseous region is between the first glass portion and the third glass portion; and
a second isolated gaseous region is between the second glass portion and the third glass portion;
at least one light source configured to emit light into the third glass portion via an edge of the third glass portion; and
a plurality of light-scattering structures arranged to scatter at least a portion of the light emitted by the at least one light source into the third glass portion in a direction substantially perpendicular to a primary face of the third glass portion.

2. The apparatus of claim 1, wherein the plurality of light-scattering structures are contained within the third glass portion.

3. The apparatus of claim 2, wherein the plurality of light-scattering structures comprise a plurality of hollow regions.

4. The apparatus of claim 3, wherein the plurality of hollow regions comprise a plurality of laser-formed hollow regions.

5. The apparatus of claim 1, further comprising a light-scattering layer adhered to the third glass portion, wherein the light-scattering layer comprises the plurality of light-scattering structures.

6. The apparatus of claim 5, wherein the light-scattering layer comprises a substantially optically clear resin.

7. The apparatus of claim 5, wherein the absolute value of a difference between an index of refraction of the light-scattering layer and an index of refraction of the third glass portion is less than or equal to 0.05.

8. The apparatus of claim 1, wherein the plurality of light-scattering structures comprise a plurality of prismatic light reflectors.

9. The apparatus of claim 8, wherein the plurality of light-scattering structures comprise a plurality of truncated pyramids.

10. The apparatus of claim 1, wherein the third glass portion comprises a visible light attenuation coefficient of less than 0.62 per meter.

11. The apparatus of claim 1, wherein a coefficient of thermal expansion for the third glass portion is less than a coefficient of thermal expansion for at least one of the first glass portion and the second glass portion.

12. The apparatus of claim 11, wherein the coefficient of thermal expansion of the third glass portion is less than the coefficient of thermal expansion for both of the first glass portion and the second glass portion.

13. The apparatus of claim 1, wherein an intensity of light scattered from the third glass portion towards the first glass portion is greater than an intensity of light scattered from the third glass portion towards the second glass portion.

14. The apparatus of claim 1, wherein the thickness of the third glass portion is substantially constant.

15. An apparatus, comprising:
a first glass portion;
a second glass portion substantially parallel to the first glass portion;
a third glass portion between the first glass portion and the second glass portion, wherein the third glass portion is substantially parallel to the first glass portion;
a fourth glass portion between at least one of the third glass portion and the first glass portion, or the third glass portion and the second glass portion, wherein:
the fourth glass portion is substantially parallel to the first glass portion; and
three isolated gaseous regions are located between the first, second, third, and fourth glass portions;
at least one light source configured to emit light into the third glass portion via an edge of the third glass portion; and
a plurality of light-scattering structures arranged to scatter at least a portion of the light emitted by the at least one light source into the third glass portion in a direction substantially perpendicular to a primary face of the third glass portion.

16. The apparatus of claim 15, wherein the plurality of light-scattering structures are contained within the third glass portion.

17. The apparatus of claim 16, wherein the plurality of light-scattering structures comprise a plurality of hollow regions.

18. The apparatus of claim 15, further comprising a light-scattering layer adhered to the third glass portion, wherein the light-scattering layer comprises the plurality of light-scattering structures.

19. The apparatus of claim 15, wherein the plurality of light-scattering structures comprise a plurality of prismatic light reflectors.

20. The apparatus of claim 15, wherein the thickness of the third glass portion is substantially constant.

21. The apparatus of claim 15, further comprising a plurality of glass portions between at least one of the third glass portion and the first glass portion, or the third glass portion and the second glass portion.
